(19) United States
(12) Patent Application Publication
(10) Pub. No.: US 2013/0105635 A1
(43) Pub. Date: May 2, 2013

(54) QUAD TILT ROTOR VERTICAL TAKE OFF AND LANDING (VTOL) UNMANNED AERIAL VEHICLE (UAV) WITH 45 DEGREE ROTORS

(71) Applicants: Hamzeh Mahmoud Abde Quader Alzu'bi, Ain Albasha-Amman (JO); Imad Abd Allateef, Wadi Alseer-Amman (JO); Yahya Zweiri, Tla' Al Ali-Amman (JO); Basim Alkhateeb, Hatem-Irbid (JO); Ibrahem Mubarak Saleem Al-Masarwah, Tabarbour-Amman (JO)

(72) Inventors: Hamzeh Mahmoud Abde Quader Alzu'bi, Ain Albasha-Amman (JO); Imad Abd Allateef, Wadi Alseer-Amman (JO); Yahya Zweiri, Tla' Al Ali-Amman (JO); Basim Alkhateeb, Hatem-Irbid (JO); Ibrahem Mubarak Saleem Al-Masarwah, Tabarbour-Amman (JO)

(73) Assignee: King Abdullah II Design and Development Bureau

(21) Appl. No.: 13/285,246

(22) Filed: Oct. 31, 2011

(51) Int. Cl. B64C 29/00

(52) U.S. Cl. 244/23 A

(57) ABSTRACT

A system and method to control the stability and direction of a quad tilt vertical takeoff and landing (VTOL) unmanned aerial vehicle (UAV) by manipulating the rotational speed of propellers at each rotor while simultaneously tilting the rotors in a 45 degree configuration related to a central axis for directional control. Each rotor is attached to a tilting mechanism configured to be symmetrically aligned at a 45 degree angle from a central axis to manipulate a directional angle of each rotor along a first and second axis. The first and fourth rotors are aligned on the first axis while the second and third rotors are aligned on the second axis. A controller includes a first control loop for manipulating the rotational speed of the propellers to control the aircraft balance and a second control loop for controlling lateral movement by tilting the rotors along the first and second axis.

### BACKGROUND

The present exemplary embodiment relates to a vertical take-off and landing (VTOL) vehicle. It finds particular application in conjunction with unmanned aerial vehicles (UAV) having quad tilt rotors configured in 45 degree orientations, and will be described with particular reference thereto. However, it is to be appreciated that the present exemplary embodiment is also amenable to other like applications.

A UAV is a powered aircraft that manipulates aerodynamic forces to provide lift without an onboard human operator. Generally, UAVs can be flown autonomously or piloted remotely, can be expendable or recoverable, and are able to carry payloads.

VTOL is an aircraft that is subject to particular movement conditions including the abilities to vertically takeoff and land from a static position at ground level. VTOL aircrafts can hover in place and laterally maneuver while airborne. Additionally, VTOL aircraft have the ability to transition between movement phases including vertical takeoff, hover, lateral movement and landing. VTOL aircraft are desirable because a smaller area is needed for takeoff and landing than conventional runway takeoff type aircraft. However, the transitions between movement phases of a VTOL aircraft while airborne are known to create moment forces and other adverse aerial forces that cause disruption to the stability of the VTOL aircraft.

Much research is done to the UAV and VTOL technology to simplify the combined mechanical and control design to reduce the complexity and risk of failure while maintaining stability. It has been known to utilize multiple rotors to provide an improvement to vehicle balance and stability while in use. These vehicles must overcome stability issues relating to adverse moment forces caused by the environment as well as gyroscopic moment forces due to movement conditions and transitioning phases that are generated during aircraft maneuvers.

Some mechanical methods have been employed to eliminate the effects of unwanted moment forces acting on VTOL during use. In particular, the use of oblique active tilting (OAT) while incorporating longitudinal tilting of rotors has been known to address gyroscopic moment forces by providing a damping effect. However, this technique requires additional precise moving parts that increase the complexity of the mechanical design. Additional moving parts require additional maintenance and are known to cause an increased risk to vehicle failure due to higher vehicle weight and mechanical design variables.

Therefore, there is a need to provide a system and method to control the balance and stability of a VTOL UAV system that does not increase the mechanical complexity therein. Additionally, there is a need to provide a VTOL UAV system that reduces undesired moment force phenomena generated by aircraft maneuvers to increase flight effectiveness and efficiency while maintaining flight stability.

### BRIEF DESCRIPTION

The present disclosure relates to a system and method that controls stability of quad tilt rotors in a VTOL UAV by manipulating the rotational speed of propellers at each rotor while simultaneously tilting the rotors in a 45 degree configuration related to a central axis for directional flight control.

In one embodiment, the present disclosure pertains to a system for controlling a quad tilt rotor VTOL UAV. The system includes an aircraft having a first rotor spaced apart from a second rotor along a front portion of a vehicle body and a third rotor spaced apart from a fourth rotor along a rear portion of the vehicle body. A fixed blade propeller is rotably attached to each rotor such that each propeller is aligned on a common plane. Each rotor is attached to a tilting mechanism configured to be positioned at a 45 degree angle from a central axis to manipulate a directional angle of each rotor relative to a first and second axis. The first and fourth rotors are aligned on the first axis while the second and third rotors are aligned on the second axis.

The system also includes a first control loop for manipulating the rotational speed of the propellers to control the balance of the vehicle and a second control loop for controlling a thrust vector or lateral maneuvering by tilting the rotors relative to the first and second axis.

Another embodiment pertains to a quad tilt VTOL UAV including an aircraft body located along a central axis equally spaced between a plurality of rotors, each rotor having a fixed pitch propeller and being aligned on a common plane. A plurality of radially protruding arms is attached to a tilting mechanism at each rotor. The rotational speed of the propellers on each rotor is manipulated by a controller. The radially protruding arms are configured along a first axis and a second axis. The first axis intersects the central axis at 45 degree angle and the second axis intersects the central axis opposite the first axis at a 45 degree angle. Additionally, the tilting mechanisms are simultaneously modulated by a controller to tilt the rotors to maneuver the aircraft.

In yet another embodiment, provided is a method of controlling the stability and movement of a quad rotor VTOL UAV. The propellers at the plurality of rotors are rotated at an equivalent rotational speed. The angular speed and torque of the rotors are controlled by a controller. Each rotor is simultaneously tilted in a predetermined orientation to manipulate a thrust vector and lateral direction of the vehicle. The rotational speeds of each propeller are controlled to maintain balance and stability of the aircraft.

An aspect of the present disclosure is a VTOL UAV system in a 45 degree configuration with improved payload capabilities while maintaining an optimal size of aircraft components.

Another aspect of the present disclosure is a VTOL UAV system and method such that control of the rotational speed of each propeller reduces or cancels undesired gyroscopic moment forces and other torque forces acting on the aircraft that are caused by the manipulation of the tilting mechanism for directional control.

In yet another aspect of the present disclosure is a VTOL UAV system and method such that the control of the tilting mechanisms to maneuver the vehicle minimizes the complexity of the rotational speed controller. The speed controller maintains the stability of the aircraft while the tilting mechanism is modulated by a controller to manipulate the direction of the aircraft.

Still another aspect of the present disclosure is to reduce the mechanical complexity of the VTOL UAV while controlling its stability.

Still yet another aspect of the present disclosure is a VTOL UAV system that is simple and compact.

Still other features and benefits of the present disclosure will become apparent from the following detailed description.

### BRIEF DESCRIPTION OF THE DRAWINGS

FIG. 1 is a perspective view of a quad tilt VTOL UAV;

FIG. 2 is a partial perspective view of the quad tilt VTOL UAV illustrating a rotor with a tilting mechanism;

FIG. 3 is a perspective view of the quad tilt VTOL UAV illustrating a plurality of rotors manipulated for lateral directional movement along a longitudinal axis;

FIG. 4 is a perspective view of the quad tilt VTOL UAV illustrating a plurality of rotors manipulated for sideward directional movement along a longitudinal axis;

FIG. 5 is a perspective view of the quad tilt VTOL UAV illustrating the plurality of rotors manipulated for yaw movement relative to a rotational axis.

### DETAILED DESCRIPTION

It is to be understood that the detail figures are for purposes of illustrating exemplary embodiments only and are not intended to be limiting. Additionally, it will be appreciated that the drawings are not to scale and that portions of certain elements may be exaggerated for the purpose of clarity and ease of illustration.

In accordance with the present disclosure, a system and method are provided to control stability of quad tilt rotors in a vertical takeoff and landing (VTOL) unmanned aerial vehicle (UAV) by controlling the rotational speed of propellers at each rotor while simultaneously tilting the rotors aligned in a 45 degree configuration related to a central axis for directional flight control.

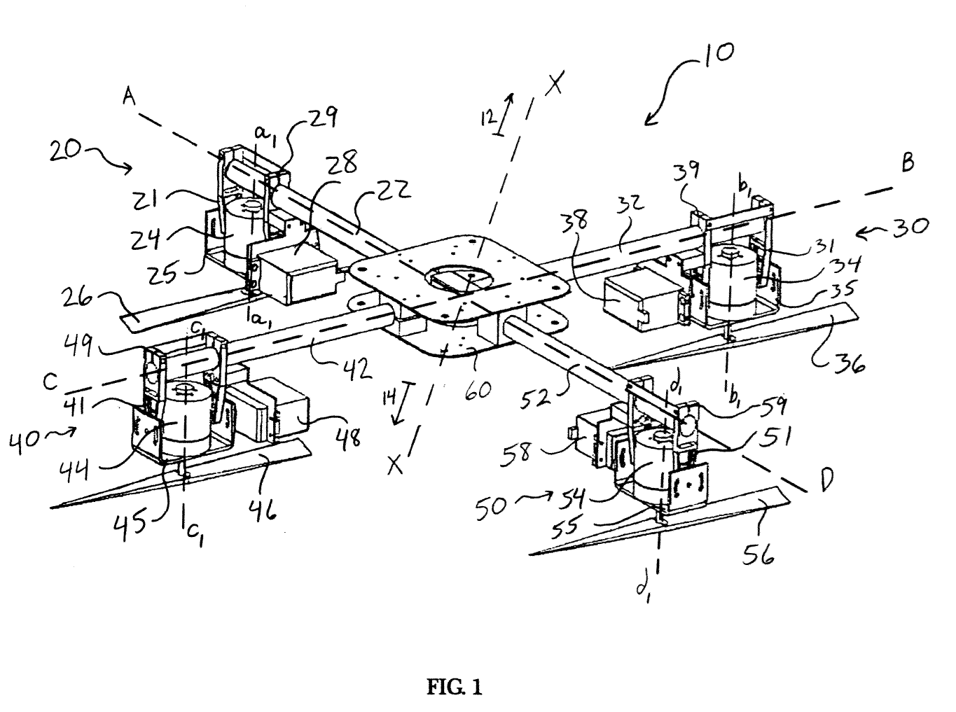

With reference to FIG. 1, a quad tilt VTOL UAV aircraft 10 preferably includes four rotors 20, 30, 40, 50 arranged in a 45 degree configuration relative to center axis x-x. The first rotor 20 is spaced apart from second rotor 30 along a front portion 12 of the aircraft 10. The third rotor 40 is spaced apart from fourth rotor 50 along a rear portion 14 of the aircraft.

Rotor 20 is attached to a tilting mechanism 21 configured to be aligned at a 45 degree angle from the front portion 12 of central axis x-x. Rotor 30 is attached to a tilting mechanism 31 configured to be aligned at a 45 degree angle, opposite rotor 20, from the front portion 12 of central axis x-x. Additionally, rotor 40 is attached to a tilting mechanism 41 configured to be aligned at a 45 degree angle from the rear portion 14 of central axis x-x. Rotor 50 is attached to a tilting mechanism 51 configured to be aligned at a 45 degree angle, opposite rotor 40, from the rear portion 14 of central axis x-x.

Rotor 20 is adapted to radial arm 22. Rotor 30 is adapted to radial arm 32. Rotor 40 is adapted to radial arm 42. Rotor 50 is adapted to radial arm 52. Each tilting mechanism is attached to the associate radial arms. In one embodiment, each radial arm is a generally elongated cylindrical tube that extends from a central body 60. Radial arm 22 is axially aligned with radial arm 52 and opposite central body 60 along first axis A-D. Radial arm 32 is axially aligned with radial arm 42 and opposite central body 60 and along second axis B-C.

The body 60 is centrally located along central axis x-x and equally spaced between the rotors such that each radial arm has a generally uniform length relative to each other that extends from the central body 60 to each associated rotor. Notably, central body 60 is illustrated as a square shaped housing for simplicity. However, central body 60 generally houses a payload including a landing kit, a controller, and a power source (not shown). The controller and power source are configured to electrically communicate with each rotor. This disclosure contemplates a variety of different central body housing types and is not limited to the type of payload and configurations that can be associated with the disclosed system.

Rotor 20 includes a motor 24 attached to a base 25. Rotor 30 includes a motor 34 attached to a base 35. Rotor 40 includes a motor 44 attached to a base 45. Rotor 50 includes a motor 54 attached to a base 55. In one embodiment, each motor is a brushless out runner type DC motor. However, this disclosure is not limited as other motor types can be used with this system.

Each motor is operable with a propeller, such as a fixed pitch propeller, that is powered to rotate about a rotational axis located along the center of each motor as illustrated in FIG. 1. Motor 24 is adapted to propeller 26 that rotates about rotational axis a₁-a₁. Motor 34 is adapted to propeller 36 that rotates about rotational axis b₁-b₁. Motor 44 is adapted to propeller 46 that rotates about rotational axis c₁c₁. Motor 54 is adapted to propeller 56 that rotates about rotational axis d₁-d₁. The rotors illustrated in FIG. 1 are configured for vertical takeoff and landing of the aircraft such that the rotational axes are generally perpendicular to an associated ground.

Each propeller is located along a common plane relative to the other. In the illustrated embodiment, each propeller is located spaced below the central body 60 on a common plane. However, in another embodiment each propeller can be spaced on a common place above the central body and radial arms.

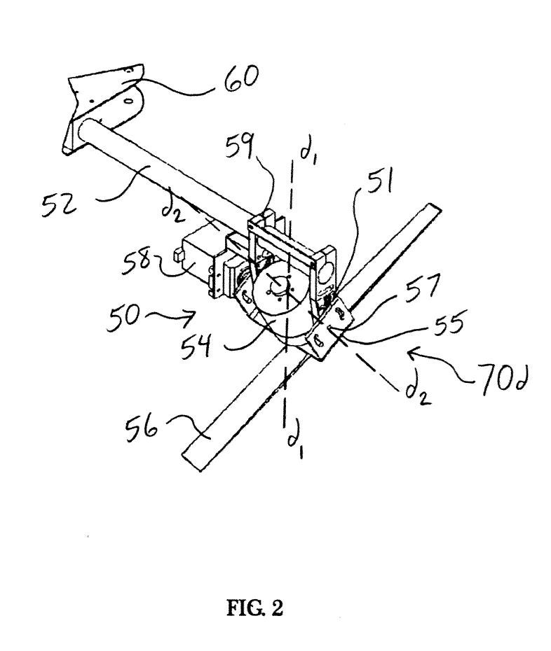

In one embodiment, the tilting mechanism 20 includes servo motor 28 that is adapted to tilt the motor 24 and propeller 26 away from rotational axis a₁-a₁. Servo motor 28 is attached to a holder 29 and an output of the servo motor 28 is directly connected to the base 25 to tilt the motor 20 in a controlled manner, as is shown in more detail by FIG. 2. Similarly, tilting mechanism 30 includes servo motor 38 that is adapted to tilt the motor 34 and propeller 36 away from rotational axis b₁-b₁. Servo motor 38 is attached to a holder 39 and an output of the servo motor 38 is directly connected to the base 35 to tilt the motor 30 in a controlled manner. Additionally, tilting mechanism 40 includes servo motor 48 that is adapted to tilt the motor 44 and propeller 46 away from rotational axis c₁-c₁. Servo motor 48 is attached to a holder 49 and an output of the servo motor 48 is directly connected to the base 45 to tilt the motor 40 in a controlled manner. Further, tilting mechanism 50 includes servo motor 58 that is adapted to tilt the motor 54 and propeller 56 away from rotational axis d₁-d₁. Servo motor 58 is attached to a holder 59 and an output of the servo motor 58 is directly connected to the base 55 to tilt the motor 50 in a controlled manner.

The system includes a controller with a first control loop for manipulating the rotational speed of the propellers for the propulsion of the aircraft and to balance the aircraft. The propeller 26 of rotor 20 is axially aligned with the propeller 56 of rotor 50 and are both rotated with a common rotational direction. The propeller 36 of rotor 30 is axially aligned with the propeller 46 of rotor 40 and both are rotated with a common rotational direction that is opposite from the rotational direction of propellers 26 and 56 of rotors 20 and 50 respectively. In one embodiment, the first control loop communicates with motors 24, 34, 44 and 54 to rotate each associated propeller at a constant rotational rate of speed relative to each other. The rotational speed is variable to increase or decrease the thrust or propulsion of the aircraft and to improve stability. Additionally, the controller includes a second control loop for controlling a thrust vector for movement of the aircraft 10 by tilting the rotors along the first axis A-D and second axis B-C in a synchronized manner.

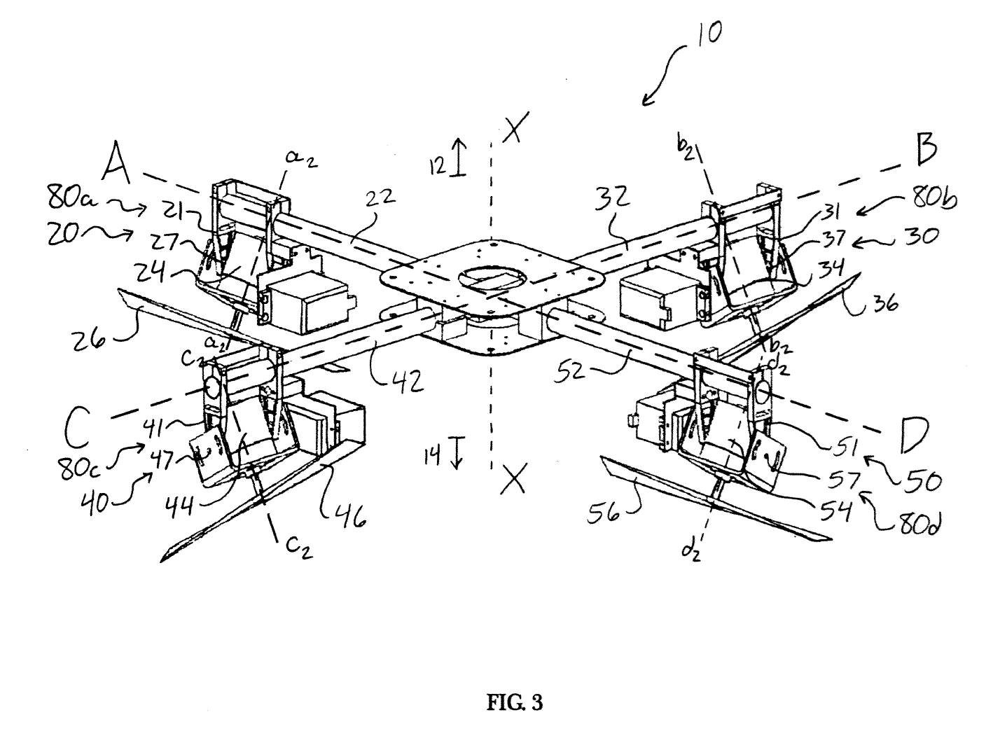

With reference to FIG. 2, rotor 50 is illustrated in an exploded view and is similarly representative of rotors 20, 30 and 40. Tilting mechanism 51 is manipulated by the controller to tilt the motor 54 away from rotational axis d₁-d₁ along a pivot point 57. Pivot point 57 is spaced from and generally parallel to radial arm 52 and located at a swivel connection between the holder 59 and the base 55. The motor 54 is powered to rotate the propeller 56 about tilt axis d₂-d₂. Tilt axis d₂-d₂ includes a planar range of motion between a first directional position 70d (as indicated at rotor 50 on FIGS. 2, 4 and 5) and a second directional position 80d (as indicated at rotor 50 on FIG. 3) of the rotor 50. Notably, rotor 50 remains along rotational axis d₁-d₁ in FIG. 1 which is a neutral or vertical thrust vectoring position along the spectrum of the range of motion of rotor 50.

With continuing attention to FIGS. 2 and 3, the planar range of motion of tilt axis d₂-d₂ of rotor 50 is generally along an axial plane in a 45 degree planar configuration relative to the rear portion 14 of central axis x-x. Also, the planar range of motion of tilt axis d₂-d₂ of rotor 50 is generally parallel to the planar range of motion of tilt axis a₂-a₂ of rotor 20. (As illustrated in FIGS. 3, 4 and 5) Similarly, the planar range of motion of tilt axis a₂-a₂ of rotor 20 is generally along an axial plane in a 45 degree planar configuration relative to the front portion 12 of central axis x-x. This configuration is also reflected by rotors 30 and 40 such that the planar range of motion of tilt axis b₂-b₂ of rotor 30 is generally along an axial plane in a 45 degree planar configuration relative to the front portion 12 of central axis x-x. The planar range of motion of tilt axis c₂-c₂ of rotor 40 is generally along an axial plane in a 45 degree planar configuration relative to the rear portion 12 of central axis x-x. Additionally, the planar range of motion of tilt axis b₂-b₂ of rotor 30 is generally parallel to the planar range of motion of tilt axis c₂-c₂ of rotor 40.

The controller is adapted to manipulate the servo motor 58 to tilt the base 55 and the motor 54 and propeller 56 thereon. The first directional position 70d and the second directional position 80d of rotor 50 are operative to maneuver the aircraft 10 along with the simultaneously manipulated tilting mechanisms 21, 31 and 41 for rotors 20, 30 and 40, respectively to achieve a desired direction of travel.

With continuing reference to FIG. 3, the controller of the aircraft 10 is controlled to simultaneously manipulate the rotors and tilting mechanisms in a predetermined manner to achieve a lateral flight direction along central axis x-x. More particularly, tilting mechanisms 21 and 51 of rotors 20 and 50, respectively are controlled to tilt motors 24 and 54 in the same angular direction relative to axis A-D. Similarly, tilting mechanisms 31 and 41 of rotors 30 and 40, respectively are controlled to tilt motors 34 and 44 in the same angular direction relative to axis B-C. Propeller 26 of rotor 20 is rotated about tilt axis a₂-a₂ in a second directional position 80a. Propeller 36 of rotor 30 is rotated about tilt axis b₂-b₂ in a second directional position 80b. Propeller 46 of rotor 40 is rotated about tilt axis c₂-c₂ in a second directional position 80c. Propeller 56 of rotor 50 is rotated about tilt axis d₂-d₂ in the second directional position 80d.

Similarly to tilting mechanism 51 of rotor 50, tilting mechanism 21 is manipulated by the controller to tilt the motor 24 away from rotational axis a₁-a₁ along a pivot point 27. Pivot point 27 is spaced from and generally parallel to radial arm 22 and located at a swivel connection between the holder 29 and the base 25. Additionally, tilting mechanism 31 is manipulated by the controller to tilt the motor 34 away from rotational axis b,-b₁ along a pivot point 37. Pivot point 37 is spaced from and generally parallel to radial arm 32 and located at a swivel connection between the holder 39 and the base 35. Tilting mechanism 41 is manipulated by the controller to tilt the motor 44 away from rotational axis c₁-c₁ along a pivot point 47. Pivot point 47 is spaced from and generally parallel to radial arm 42 and located at a swivel connection between the holder 49 and the base 45.

In this embodiment, propellers 26 and 56 are rotating in the same angular direction and are tilted to face the same direction relative to the central axis x-x. Propellers 36 and 46 rotate in the same angular direction and are tilted to face the same direction relative to the central axis x-x. Notably, propellers 26 and 56 rotate in an opposite rotational direction than propellers 36 and 46. This configuration allows for lateral maneuver of the aircraft 10 towards the front 12 or rear 14 portions of the central axis x-x as determined by the pitch and rotational direction of each propeller. Optionally, each rotor could be oppositely tilted relative to this configuration to achieve the directly opposite lateral motion.

All four propellers are controlled to rotate with similar rotational speed. However, the propellers from rotors 20 and 50 rotate in the opposite direction from the propellers of rotors 30 and 40 such that adverse torque forces and gyroscopic moment forces are reduced or even canceled. Preferably, each tilting mechanism of each rotor are controlled to tilt with the same angular tilting rate along their respective planar range of motion to maintain balance by the reduction or even cancelation of torque and moment forces.

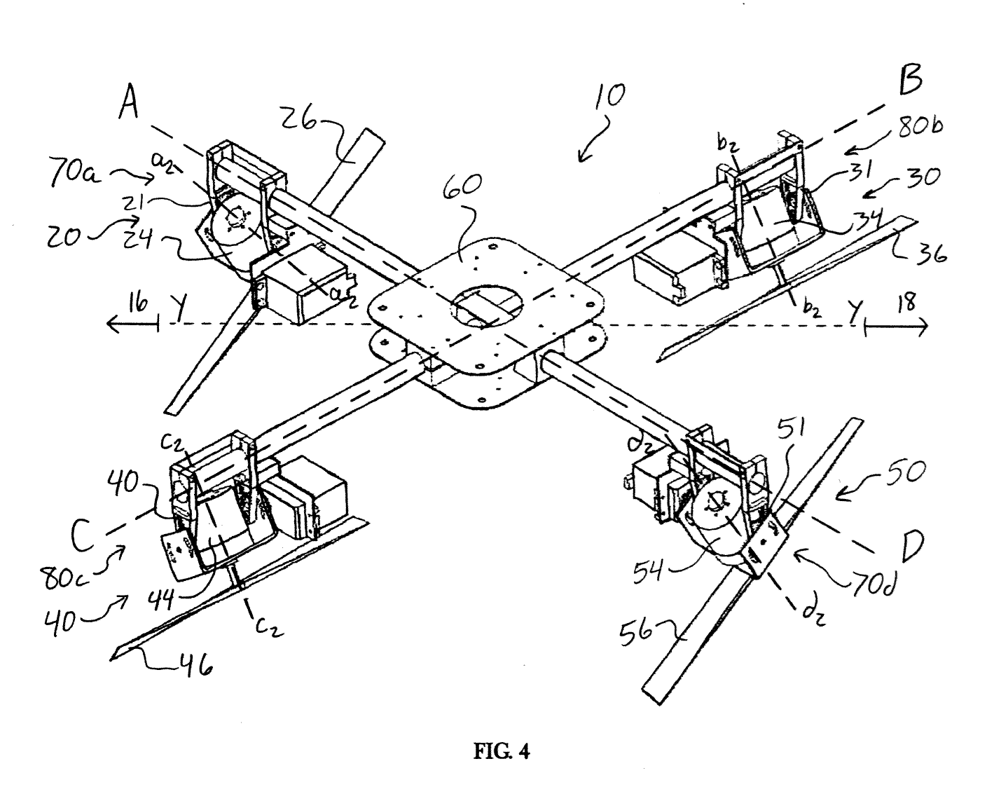

With reference to FIG. 4, the controller of the aircraft 10 is controlled to simultaneously manipulate the rotors and tilting mechanisms in a predetermined manner to achieve a sideward direction of travel along lateral axis y-y. More particularly, tilting mechanisms 21 and 51 of rotors 20 and 50, respectively are controlled to tilt motors 24 and 54 in the same angular direction relative to axis A-D. Similarly, tilting mechanisms 31 and 41 of rotors 30 and 40 respectively are controlled to tilt motors 34 and 44 in the same angular direction relative to axis B-C. Rotor 20 is rotated about tilt axis a₂-a₂ in a first directional position 70a. Rotor 30 is rotated about tilt axis b₂-b₂ in the second directional position 80b. Rotor 40 is rotated about tilt axis c₂-c₂ in the second directional position 80c. Rotor 50 is rotated about tilt axis d₂-d₂ in the first directional position 70d.

In this embodiment, propellers 26 and 56 are rotating in the same angular direction and are tilted to face the same direction relative to the central axis x-x. Propellers 36 and 46 rotate in the same angular direction and are tilted to face the same direction relative to the central axis x-x. Notably, propellers 26 and 56 rotate opposite rotational direction than propellers 36 and 46. This configuration allows for lateral maneuver of the aircraft 10 towards a first side direction 16 or an opposite second side direction 18 along the lateral axis y-y as determined by the pitch and rotational direction of each propeller. Optionally, each rotor could be oppositely tilted relative to this configuration to achieve the directly opposite lateral motion.

All four propellers are controlled to rotate with similar rotational speed. However, the propellers from rotors 20 and 50 rotate in the opposite direction from the propellers of rotors 30 and 40 such that adverse torque forces and gyroscopic moment forces can be reduced or even canceled. Each tilting mechanism of each rotor are controlled to tilt with the same angular tilting rate along their respective planar range of motion to maintain balance by the reduction or even cancelation of torque and moment forces.

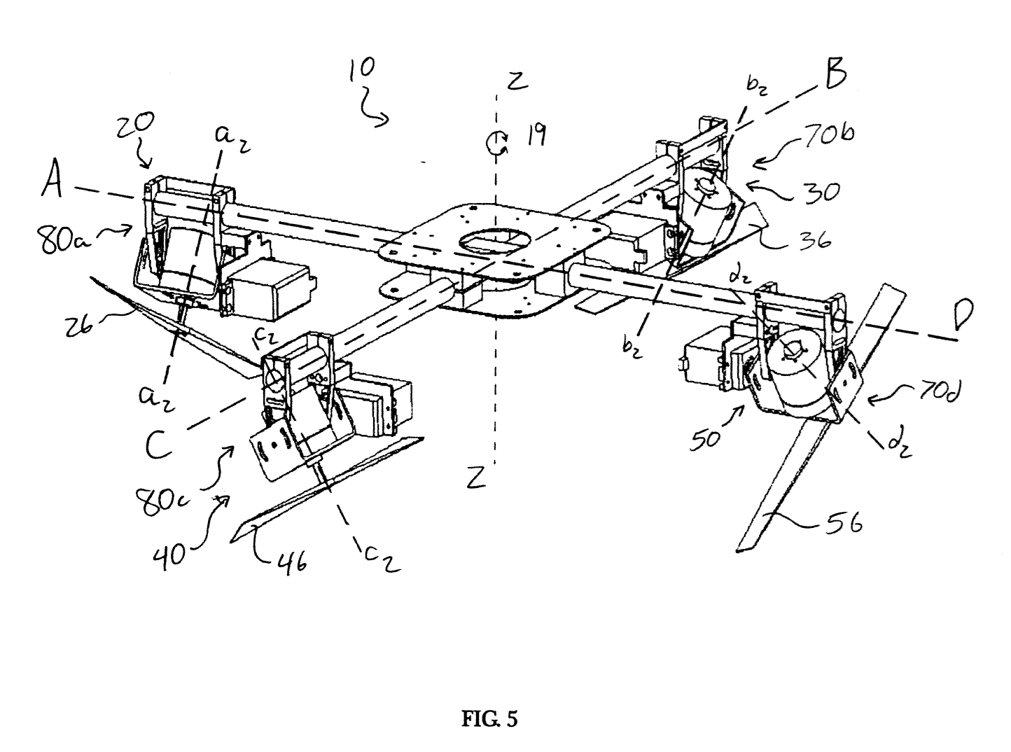

With reference to FIG. 5, the controller of the aircraft 10 is controlled to simultaneously manipulate the rotors and tilting mechanisms in a predetermined manner to achieve a rotation or yaw movement 19 about rotational axis z-z. More particularly, tilting mechanisms 21 and 51 of rotors 20 and 50 respectively are controlled to tilt motors 24 and 54 in the opposite angular direction relative to axis A-D. Similarly, tilting mechanisms 31 and 41 of rotors 30 and 40 respectively are controlled to tilt motors 34 and 44 in the opposite angular direction relative to axis B-C. Rotor 20 is rotated about tilt axis a₂-a₂ in the second directional position 80a. Rotor 30 is rotated about tilt axis b₂-b₂ in a first directional position 70b. Rotor 40 is rotated about tilt axis c₂-c₂ in the second directional position 80c. Rotor 50 is rotated about tilt axis d₂-d₂ in the first directional position 70d. Notably, tilt axis c₂-c₂ of rotor 40 can also be tilted in a first directional position 70c (Not shown).

In this embodiment, propellers 26 and 56 are rotating in the same angular direction and are tilted to face the opposite direction relative to axis A-D. Propellers 36 and 46 rotate in the same angular direction and are tilted to face the opposite direction relative to axis B-C. Notably, propellers 26 and 56 rotate in an opposite rotational direction than propellers 36 and 46. This configuration allows for a rotational maneuver of the aircraft 10 in a yaw type movement along the rotational axis z-z as determined by the pitch and rotational direction of each propeller. All four propellers are controlled to rotate with similar rotational speed. However, the propellers from rotors 20 and 50 rotate in the opposite direction from the propellers of rotors 30 and 40 such that adverse torque forces and gyroscopic moment forces can be reduced or even canceled. Each tilting mechanism of each rotor are controlled to tilt with the same angular tilting rate along their respective planar range of motion to maintain balance by the reduction or even cancelation of torque and moment forces.

The exemplary embodiment has been described with reference to the preferred embodiments. Obviously, modifications and alterations will occur to others upon reading and understanding the preceding detailed description. For example, while discussed generally as a UAV, the concepts described herein are also applicable to manned aircraft. It is intended that the exemplary embodiment be construed as including all such modifications and alterations insofar as they come within the scope of the appended claims or the equivalents thereof.

1. A system for controlling a quad tilt rotor vertical takeoff and landing unmanned aerial vehicle comprising:
a first rotor spaced apart from a second rotor along a first axis of a vehicle body and a third rotor spaced apart from a fourth rotor along a second axis of the vehicle body, each rotor having a propeller aligned on a common plane and having a tilting mechanism for manipulating the directional angle of each rotor along an axis that is configured 45 degrees from a central axis;
a first control loop for manipulating the rotational speed of the propellers to control the balance of the vehicle; and
a second control loop for controlling a thrust vector by tilting the rotors.

2. The system in accordance with claim 1 wherein the thrust vector of the vehicle is controlled to maneuver in a lateral direction along the central axis.

3. The system in accordance with claim 2 wherein the rotors of the first axis and the rotors of the second axis are equally spaced from the central body.

4. The system in accordance with claim 3 wherein the first axis is generally perpendicular to the second axis.

5. The system in accordance with claim 3 wherein the first axis intersects the second axis along the central axis.

5. The system in accordance with claim 1 wherein each rotor includes a propeller having a plurality of fixed pitch blades.

6. The system in accordance with claim 1 wherein each rotor includes a brushless outrunner DC powered motor.

7. The system in accordance with claim 1 wherein each tilting mechanism is controlled to simultaneously tilt each rotor to control the direction of the vehicle while each propeller is controlled to rotate at an equal rotational speed to improve the stability and balance of the vehicle in use.

8. The vehicle in accordance with claim 1 wherein the propellers of the first and fourth rotors are rotated in the same rotational direction, the propellers of the second and third rotors are rotated in the same rotational direction and opposite the direction of the propellers of the first and fourth rotors.

9. A quad tilt vertical takeoff and landing unmanned aerial vehicle comprising:
an aircraft body centrally located between a plurality of rotors along a central axis, each rotor having a fixed pitch propeller aligned on a common plane;
a plurality of radially protruding arms, each am, being attached to a rotor and a tilting mechanism;
a controller for controlling the rotational speed of the propellers on each rotor; and
a controller for modulating the tilting mechanisms to tilt the rotors and control the direction of the vehicle.

10. The vehicle in accordance with claim 9 wherein the common plane is spaced from the radially protruding arms.

11. The vehicle in accordance with claim 9 wherein four rotors are attached to four radial arms protruding from the central body, a first arm is attached to a first rotor along a first axis, the second arm is attached to the second rotor along a second axis, the third arm is attached to the third rotor directly opposite the second arm along the second axis, the fourth arm is attached to the fourth rotor directly opposite the first arm along the first axis.

12. The vehicle in accordance with claim 11 wherein the first axis intersects the central axis at 45 degree angle and the second axis intersect the central axis opposite the first axis at a 45 degree angle.

13. The vehicle in accordance with claim 9 wherein the aircraft body is centrally located between four rotors.

14. The vehicle in accordance with claim 13 wherein each tilting mechanism is controlled to simultaneously tilt each rotor and control the direction of the vehicle while each propeller is controlled to rotate at a controlled rate for the stability and balance of the vehicle in use.

15. The vehicle in accordance with claim 14 wherein the propellers are rotated at a generally equal rotational rate.

16. The vehicle in accordance with claim 9 wherein the propellers of the first and fourth rotors are rotated in the same rotational direction, the propellers of the second and third rotors are rotated in the same rotational direction and opposite the direction of the propellers of the first and fourth rotors.

17. The vehicle in accordance with claim 9 wherein each rotor includes a propeller having a plurality of fixed pitch blades.

18. The vehicle in accordance with claim 9 wherein each rotor includes a brushless outrunner DC powered motor.

19. A method of controlling the stability of a quad tilt rotor vertical takeoff and landing unmanned aerial vehicle including four rotors such that the first and fourth rotors are aligned on a first axis and the second and third rotors are aligned on a second axis, the steps comprising:
rotating a propeller on each rotor at generally equal rotational rate such that the propellers along the first axis are rotated in a different rotational direction than the propellers along the second axis; and
tilting each rotor simultaneously in a predetermined orientation to manipulate a thrust vector and control the direction of the vehicle.

20. The method in accordance with claim 16 wherein the step of rotating the propellers includes controlling a rotational speed of each propeller to maintain balance and stability of the vehicle.
